(19) United States
(12) Patent Application Publication
(10) Pub. No.: US 2012/0124081 A1
(43) Pub. Date: May 17, 2012

(54) METHOD AND SYSTEM FOR PROVIDING DATA MIGRATION

(75) Inventors: Fariborz Ebrahimi, Basking Ridge, NJ (US); Shankar Srinivasan Harihara, Irving, TX (US); Walid Hassan, Irving, TX (US); Sumit Singh, Irving, TX (US); Brian Matthew Vanderwiel, San Marcos, CA (US); Rami El-Youssef, Irving, TX (US); Terry Dean Boepple, Keller, TX (US); Thillainathan Ponnambalam, Irving, TX (US)

(73) Assignee: VERIZON PATENT AND LICENSING INC., Basking Ridge, NJ (US)

(21) Appl. No.: 12/948,506

(22) Filed: Nov. 17, 2010

(51) Int. Cl. G06F 17/30

(52) U.S. Cl. 707/769; 707/803; 707/E17.005

(57) ABSTRACT

An approach is provided for data migration. Table structure data associated with a logical table is extracted from a source database. Raw data associated with the logical table is extracted from the source database. A table structure in a target database is generated based on the table structure data. The raw data is loaded into the table structure in the target database.

### BACKGROUND INFORMATION

Information systems are integral to an organization or business operations. These systems provide an integrated platform for managing a variety of business functions, processes and procedures including: manufacturing, supply chain management, finances, project management, human resources, customer relationship management and generalized data services. Each business management system is generally supported by a database, which contains data that is shared amongst the various software components that perform the business tasks relating to the particular business operation. Given the dynamic environment of business, it is not uncommon for organizations to continually restructure departments or even merge with other entirely different organizations, or for other cost reduction measures. Hence, it may become necessary, for example, to decommission an information system and to transfer the underlying database to a different business management system. For example, in the case of a merger or acquisition, the acquiring company may wish to integrate the acquired company's data into the acquiring company's business management system. Consequently, data migration between the source system to a target system is necessary.

However, the transfer of a source database into a target system presents a number of issues. Notably, incompatibility among the database systems pose significant challenges; that is, the target system may be designed and developed based on a different database technology than that used in the source business management system. Additionally, the data itself may be defined and formulated differently. This requires examining data compatibility from a semantic and data structure level.

Based on the foregoing, there is a need for an approach that permits the seamless migration of a source business management system database into a target business management system.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing data migration from a source system to a target system, according to an exemplary embodiment;

FIG. 2 is a flowchart of a data migration process performed by the system of FIG. 1, according to an exemplary embodiment;

FIG. 3 is a diagram of a system capable of providing data migration from a source business management system to a target business management system, according to an exemplary embodiment;

FIG. 4 is a flowchart of a process for migrating data involving handling of raw data, according to an exemplary embodiment;

FIG. 5 is a flowchart of a process for extracting raw data from logical tables, according to an exemplary embodiment;

FIG. 6 is a flowchart of a process for loading raw data into the table structure on a target database management system, according to an exemplary embodiment;

FIGS. 7A and 7B are a flowchart of a process for testing data integrity of tables transferred to a target database management system, according to an exemplary embodiment;

FIG. 8 is a flowchart of a process for extracting table structure files for logical tables, according to an exemplary embodiment;

FIG. 9 is a flowchart of a process for determining the number of records in logical tables according to an exemplary embodiment;

FIG. 10 is a flowchart of a process for extracting raw data from logical tables that are smaller than specified limits, according to an exemplary embodiment;

FIG. 11 is a flowchart of a process for extracting raw data from logical tables that are greater than specified limits, according to an exemplary embodiment;

FIG. 12 is a flowchart of a process for obtaining field count and row count information from logical tables, according to an exemplary embodiment;

FIG. 13 is a flowchart of a process for validating date fields between source and target logical tables, according to an exemplary embodiment;

FIG. 14 is a diagram of a computer system that can be used to implement various exemplary embodiments; and

FIG. 15 is a diagram of a chip set that can be used to implement various exemplary embodiments.

### DESCRIPTION OF THE PREFERRED EMBODIMENT

A preferred apparatus, method, and software for providing data migration are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a conversion of a source database management system utilizing logical database structures, it is contemplated that these embodiments have applicability to other equivalent database structures.

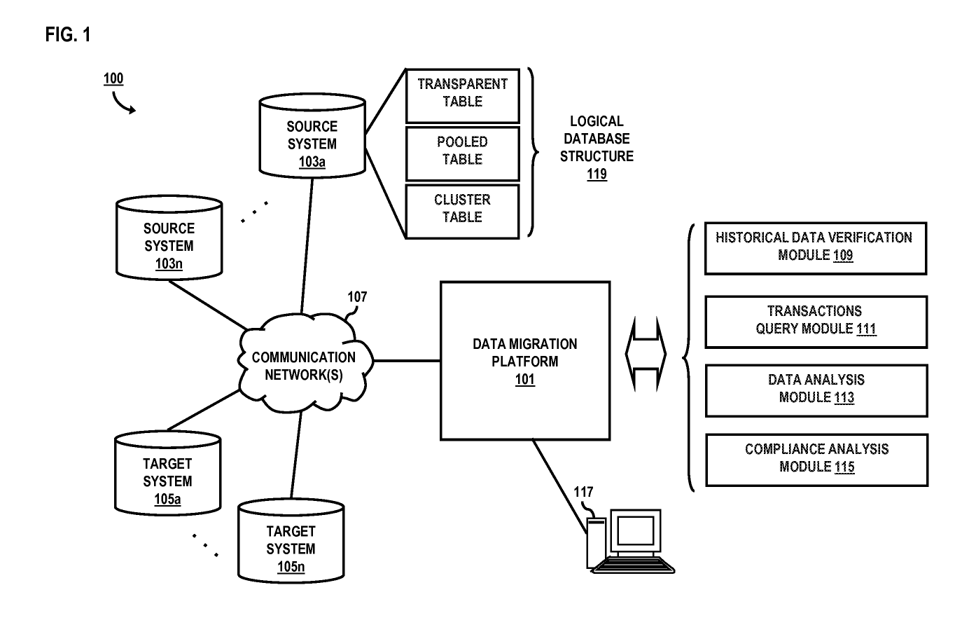

FIG. 1 is a diagram of a system capable of providing data migration from a source system to a target system, according to an exemplary embodiment. For purposes of illustration, system 100 utilizes a data migration platform 101 that communicates with one or more source systems 103a-103n and target systems 105a-105n over a communication network 107. The source systems 103a-103n can be associated with a single entity (organization, business, etc.) or multiple distinct entities. Similarly, the target systems 105a can be operated by one or more entities. As mentioned, data migration can stem from the merger of two or more entities, whereby compatibility issues arise among the respective information systems. Also, upgrading or replacement of information systems can introduce such issues, as, for instance, middleware and application software may not be upgraded because old redundant versions cannot be supported on the new hardware and middleware software. It is noted that each of the source system 103 and the target system 105, according to one embodiment, has an underlying database and associated database management system that is configured to store and manage data in support of various tasks and transactions.

In a database management system (e.g., target system 105), data can be stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

According to certain embodiments, data migration platform 101 facilitates the seamless conversion of data from a source system 103 to a target system 105 through the use of the following modules: a data verification module 109 configured to verify historical data; a transactions query module 111 configured to process queries regarding past transactions; a data analysis module 113 configured to examine historical data and perform trend analysis; and a compliance analysis module 115 configured to process the data for compliance requirements (e.g., legal, arbitration, etc.). In certain embodiments, the data migration platform 101 can be managed by a service provider, which can offer data migration services—e.g., as a managed service. As will be more evident, the platform 101 employs a data migration process that provides, in certain embodiments, a number of advantages, such as reduced costs relating to equipment, infrastructure (e.g., power, air-conditioning, rack space, and facility), human resources, and maintenance.

As shown, platform 101 can be accessed directly with a terminal 117, which can be any type of computing device. Alternatively, the terminal 117 can communicate over the communication network 107, which may include one or more networks such as a data network and/or a telephony network. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. Moreover, the telephony network can be provided via a combination of circuit-switched technologies or a packetized voice infrastructure.

For the purpose of illustration, the communication network 107 can include a radio network that supports a number of wireless terminals, which may be fixed or mobile, using various radio access technologies. According to one exemplary embodiment, radio technologies that can be contemplated include: first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), 4G, etc. For instance, various mobile communication standards have been introduced, such as first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), and beyond 3G technologies (e.g., third generation partnership project (3GPP) long term evolution (3GPP LTE), 3GPP2 universal mobile broadband (3GPP2 UMB), etc.).

Complementing the evolution in mobile communication standards adoption, other radio access technologies have also been developed by various professional bodies, such as the Institute of Electrical and Electronic Engineers (IEEE), for the support of various applications, services, and deployment scenarios. For example, the IEEE 802.11 standard, also known as wireless fidelity (WiFi), has been introduced for wireless local area networking, while the IEEE 802.16 standard, also known as worldwide interoperability for microwave access (WiMAX) has been introduced for the provision of wireless communications on point-to-point links, as well as for full mobile access over longer distances. Other examples include Bluetooth™, ultra-wideband (UWB), the IEEE 802.22 standard, etc.

As mentioned, incompatibility of data can involve the actual data structure. By way of example, source system 103a may utilize a logical database structure 119 that is incompatible with the structure of target system 105a. In other words, the transfer or migration process may confounded by the presence of logical tables in a source database. Such a scenario exists, for example, with a SAP™ database system. A logical table is not represented by a single physical table in a database. Instead, a logical table may be represented indirectly by information stored in a physical table in of database. The data migration process thus needs to account account the abstract relationship between logical and physical tables.

As seen in FIG. 1, a logical database structure 119 encompasses three types of tables: transparent table, pooled table, and cluster table. Transparent tables exist with the same structure both in the dictionary and in the database with respect to the data and fields. Pooled tables are used to store control data, and must be assigned to a table pool when they are defined. As the label suggests, multiple pooled tables are combined in a “table pool.” The data of these pooled tables are can be sorted in a common table in the database. Lastly, cluster tables are logical tables that must be assigned to a table cluster. Cluster tables can also be used to store control data, and can be used to store temporary data or texts, such as documentation.

In this example, source system 103a implements an information system, whereby the data characteristics of most of the transaction data are kept in transparent/pool tables. Also, cluster tables are used for storing temporary text and values. Given this characteristic of system 103a, transaction data can be from the underlying database via the transparent and pool tables if the exact logic for reading data is clearly known. Functional consultants can extract the information about the transactions from the underlying database without using an interface configured to process the logical tables. With respect to data migration of system 103a, a major effort lies in analyzing the report requirements on the historic data present in dormant systems and decoding the specific logic of aggregation and segregate n embedded in the functional modules and Advanced Business Application Programming (ABAP) programs (assuming source system 103a is an SAP™ native system). ABAP programs are written in application-specific fourth-generation languages (4GLs) to provide reports and interfaces. In summary, such constraints pose significant obstacles to efficient migration of data, while maintaining high data integrity.

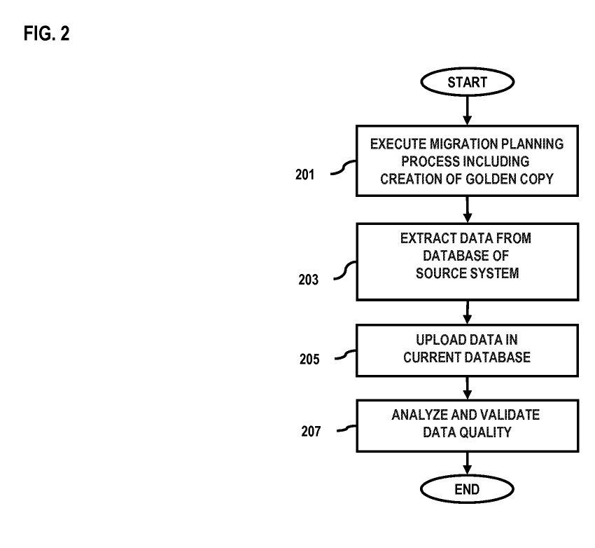

FIG. 2 is a flowchart of a data migration process performed by the system of FIG. 1, according to an exemplary embodiment. In this example, the data migration process involves a source system 103a that employs logical database structures to store its data, and a target system 105a that utilizes a data mart with standardized database structures. A data mart is part of a data warehouse that organizes a business's information according to specific business functions; the data stores corresponding to these business functions are term “data marts.” In step 201, migration planning is performed involving creation of a “golden copy” (or master copy) of a backend database and restoration of this copy into a data mart corresponding the target system 105a. During this migration planning step, the record count of pooled tables and cluster tables can be determined. These tables can then be segregated to a predetermined threshold value (e.g., greater than 1 million records) for more expedient processing—e.g., parallel processing.

Next, data is extracted from the database of the source system 103a, as in step 203. The data structures, e.g., data definition language (DDL), are determined during this process. The data is then uploaded to the current database, per step 205. As used herein, the “current” database refers to the database within the target system 105a prior to merge of data with the source database. Thereafter, the process analyzes and validates the quality of the data (step 207).

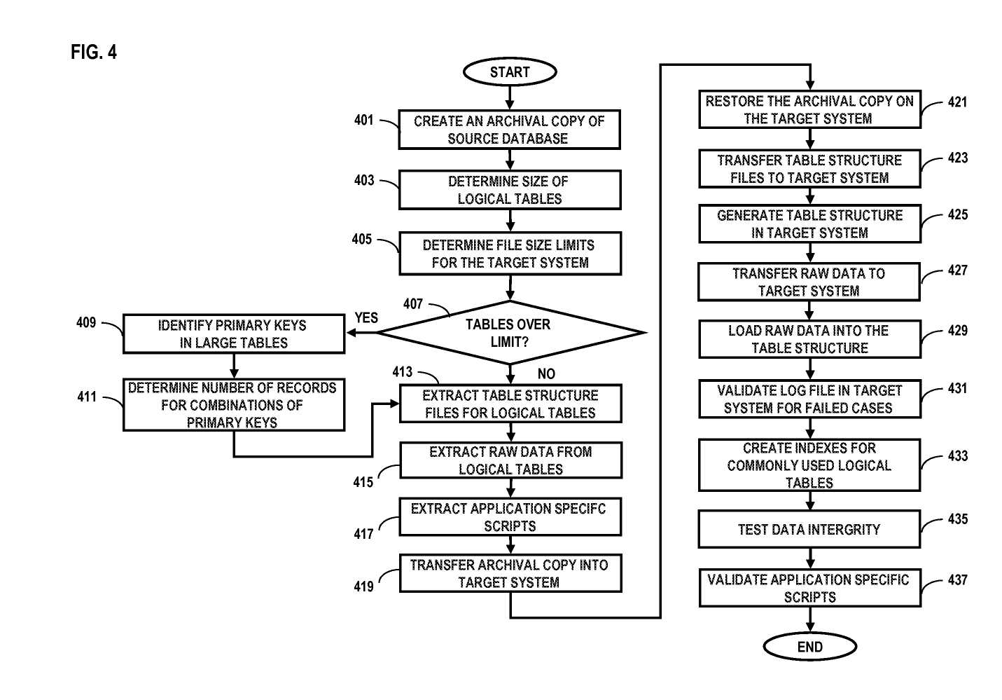

The above process is more fully described with respect to FIGS. 4-13.

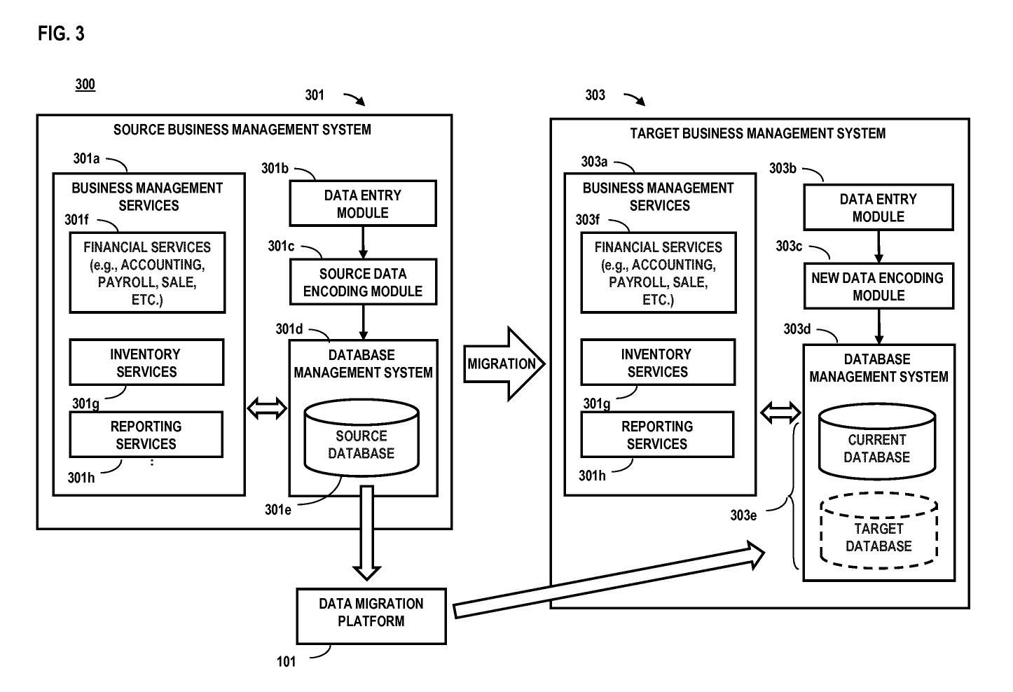

FIG. 3 is a diagram of a system capable of providing data migration from a source business management system to a target business management system, according to an exemplary embodiment. Under this scenario, system 300 implements a data migration process between two systems: a source business management system 301 and a target business management system 303. The source business management system 301 may be live and running in production, or dormant; the dormancy can stem from being redundant due to mergers, acquisitions or other similar organizational activities. The source and target business management systems 301 and 303 comprise business management system services modules 301a and 303a to support any number of business functions and transactions. The systems 301 and 303 also utilize data entry modules 301b and 303b, respectively, to obtain data that can be supplied from various data input devices and sources. The acquired data can then be encoded using the corresponding data encoding modules 301c and 303c. Database management systems 301d and 303d are provided to manage and store the encoded data in the databases 301e and 303e, respectively.

As shown, the business management service modules 301a and 303a include components for providing various services related to business management, such as financial services 301f and 303f, inventory services 301g and 303g and reporting services 301h and 303h. These services are supported by the source and target database management systems 301d and 303d that maintain data in source database 301e and current/target databases 303e, respectively. As mentioned, the current database denotes the state of the target system's data prior to the data migration process.

To retrieve and store data associated with the various business services, the business management service modules 301a and 303a interact with the corresponding database management systems 301d or 303d through the corresponding data entry modules 301b or 303b and the data encoding modules 301c or 303c. The data entry modules 301b and 303b can receive input data from an input unit, such as a key board, a hard drive, etc. (not shown) and transfer the input data to the corresponding data encoding module 301c-303c. Also, the data encoding modules 301c-303c encode the data based on the standards defined in the technology adopted by the corresponding business management system 301 and 303. The encoded data controls the transfer of data between the database management systems 301d-303d and the corresponding business management services 301a-303a.

For the target business management system 303 to be able to access and use data from the source business management system 301, the data from source database 301e and the related logical structure of its corresponding data dictionary need to be ported to a structure that is readable by the target database management system 303d. Exemplary data dictionaries are more fully described below. The data migration platform 101 performs the porting process for source database 301e so that it is integrated into the logical structure of the target business management system 303. The results of the interpretation process are stored in the target business management system 303 as target database 303e and associated backup data dictionary (not shown). For the purposes of explanation, database 303e is referred to both the current database and the target database. Under this scenario, the target database 303e has the same logical structure used by the target business management system 303. Accordingly, the target database can be used in combination with the current database; it is contemplated, however, that the target database can be used independently of the current database and the current data dictionary for answering to queries about past data that their related data may not be available in the current database.

In one embodiment, the data encoding modules 301c-303c, may create one or more tables of data describing the structure and the underlying logic of data tables. This logical data can be defined and stored as part of a data dictionary (not shown). The data dictionary may also describe the logical structures of the objects used in application development and show how they are mapped to the underlying relational database in tables or views. For example, one type of file in the data dictionary may include tables having a one-to-one relation with the tables in the database (e.g., a “transparent table” in the SAP™ nomenclature). The structure of a transparent table corresponds to single database field. A table in the database has the same name as in the dictionary. Transparent tables typically hold application data.

In one embodiment, the source business management services 301a interact with the source database management system 301d through logical tables that do not have a one-to-one relationship with a physical table in the source database 301e. Instead, a single physical table in the source database 301e may store information corresponding to a number of logical tables (e.g., pooled tables and cluster tables). As explained previously, pooled tables and cluster tables are generally used to store control data (e.g. program parameters).

Pooled tables are assigned to a table pool, which is stored in a common table in the source database 301e. Table 1 depicts an exemplary pooled table. As depicted, the table may contain commands for creating other tables in the database, definitions of data fields in the created tables, and the primary keys of the created tables.

TABLE 1

CREATE TABLE T1 (
OBJECT VARCHAR2 ( 10 ) ,
ADMI_RUN VARCHAR2 ( 6 ) ,
PRIMARY KEY ( OBJECT )
);
CREATE TABLE T2 (
SANLFOR VARCHAR2 ( 3 ) ,
SFGTYP VARCHAR2 ( 3 ) ,
PRIMARY KEY ( SANLFOR,SFGTYP )
);
CREATE TABLE T3 (
SPRAS VARCHAR2 ( 1 ) ,
SANLFOR VARCHAR2 ( 3 ) ,
SFGTYP VARCHAR2 ( 3 ) ,
XTEXT VARCHAR2 ( 30 ) ,
PRIMARY KEY ( SPRAS,SANLFOR,SFGTYP )
);

A data dictionary may also include other file types, such as a file representing a logical table that is assigned to a table cluster when they are defined (e.g., cluster table). As with pooled tables, cluster tables can specify control data, and can be used to store temporary data or texts, such as documentation. Table 2 shows an exemplary cluster table.

TABLE 2

CREATE TABLE C1 (
MANDT VARCHAR2 ( 3 ) ,
BELNR VARCHAR2 ( 10 ) ,
BUREG VARCHAR2 ( 3 ) ,
LFDNR VARCHAR2 ( 3 ) ,
BREST NUMBER ( 15 ) ,
RLFNR VARCHAR2 ( 3 ) ,
PLFNR VARCHAR2 ( 4 ) ,
SLFNR VARCHAR2 ( 4 ) ,
ATTYP VARCHAR2 ( 2 ) ,
ATVAL VARCHAR2 ( 15 ) ,
PRIMARY KEY ( MANDT,BELNR,BUREG,LFDNR )
);
CREATE TABLE C2 (
MANDT VARCHAR2 ( 3 ) ,
BELNR VARCHAR2 ( 10 ) ,
LFDNR VARCHAR2 ( 5 ) ,
OBJNR VARCHAR2 ( 22 ) ,
PRIMARY KEY ( MANDT,BELNR,LFDNR )
);

As seen in Table 2, a cluster table has a structure similar to a pooled table. The main difference between the types of tables depicted in Table 1 and Table 2 is that a pooled table of Table 1 is an integration of two or more tables. Pooled tables enhance efficiency by reducing time of search by binary search, while cluster tables are similar to pooled tables where all the tables having similar primary keys are clustered together. For example in Table 2, the primary key for both tables C1 and C2 includes fields “MANDT”, “BELNR”, and “LFDNR”.

In view of the above discussion, it is clear that data migration can be problematic considering the differences in the structures and dictionaries of data among two or more databases.

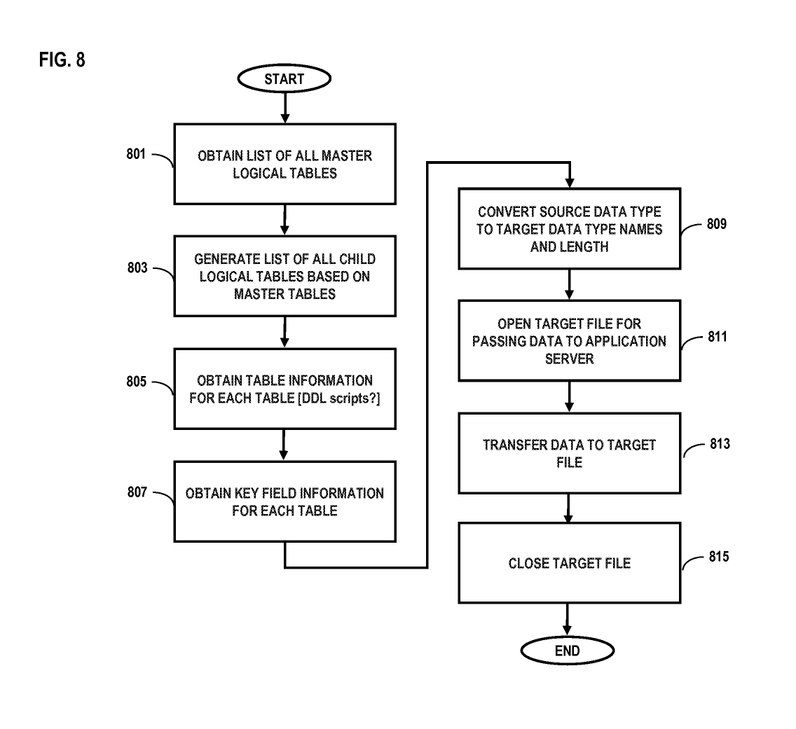

FIG. 4 is a flowchart of a process for migrating data involving handling of raw data, according to an exemplary embodiment. For the purposes of illustration, the data migration process is described with respect to the data migration process of FIG. 3, which results in the effective transfer of source database 301e into the target database management system 303d. In step 401, an archival copy of the source database 301e of FIG. 1 is made. In step 403, the process determining the size of logical tables in the source database 301e. In step 405, the file size limits of the target database management system 303d are determined. In step 407, the data migration platform 101 determines whether any logical tables in the source database 301e exceed the determined file size limits. The file size limit equates to a limit on the number of records (i.e., upper threshold) in a table. In one embodiment, the process determines whether logical tables have more records than this limit threshold (e.g., one million records); the determination of this limit may be based on performance data of processing resources, historical trend, etc. An exemplary process for determining the number of records in a table will be described below with reference to FIG. 8.

For logical tables that are above the limit, the process, per step 409, identifies the primary keys in the large logical tables that can be used to extract large blocks of related data. Examples of such primary keys include Company Code, Fiscal Year and BELNR. In step 411, the number of records for combinations of primary keys is determined. This information is used to extract data from the tables.

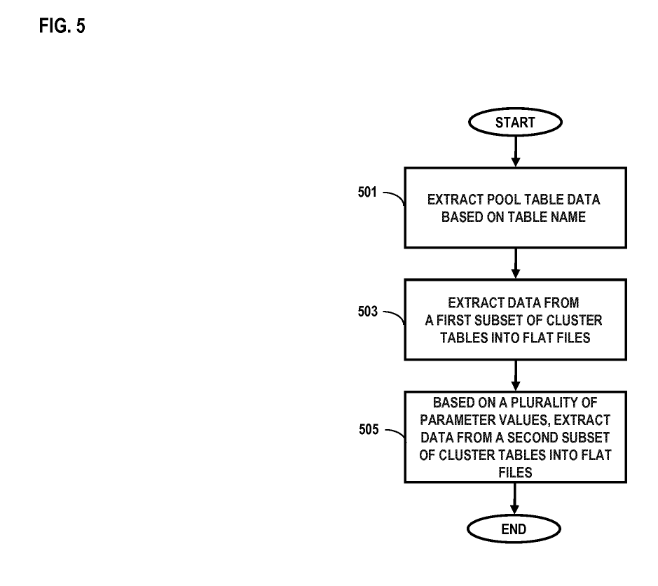

Next, in step 413, if the data migration process determines that no tables are over the limit, the table structure for logical tables in the source database is extracted (step 413). In one embodiment, the table structure for logical tables is stored in the form of Data Definition Language (DDL) commands. An exemplary process for extracting table structure will be described below with reference to FIG. 8. In step 415, the raw data from logical tables is extracted; an exemplary process extraction of the logical table structure is described below with reference to FIGS. 5, 10 and 11.

In step 417, application specific scripts are extracted from the source business management services software. An example of an application specific script is a report generation program. In the SAP™ system, application specific scripts are written in the ABAP (Advanced Business Application Programming) programming language.

In step 419, the archival copy of the source database is transferred to the target database management system 303d; and in step 421, the archival copy is restored on the target database management system 303d.

By way of example, the source business management services 301a of can be an SAP™ system, in which transparent tables from the source database 301e may directly interact with the target database management system 303d upon restoration of the archival copy. However, logical tables from the source database 301e require additional processing before they become available to the target database management system 303d.

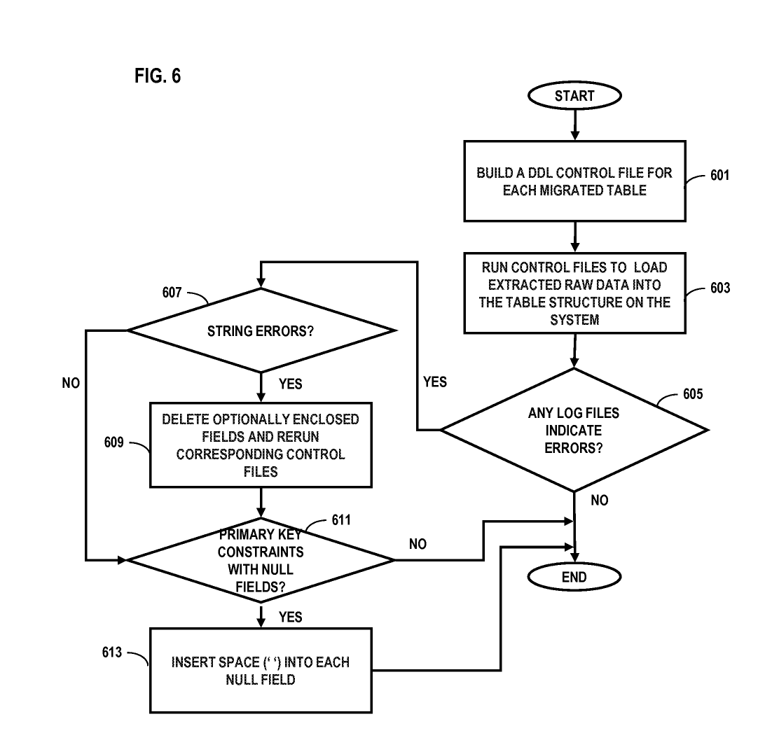

Logical files are made available as follows. In step 423, the table structure files for the logical tables are transferred to the target database management system 303d; and in step 425, these files are used to generate the table structure on the target database management system 303d. Next, in step 427, the raw data from the logical tables is transferred to the target database management system 303d. In step 429, this raw data is loaded into the table structure. An exemplary process for loading the raw data into the table structure will be described below with reference to FIG. 6.

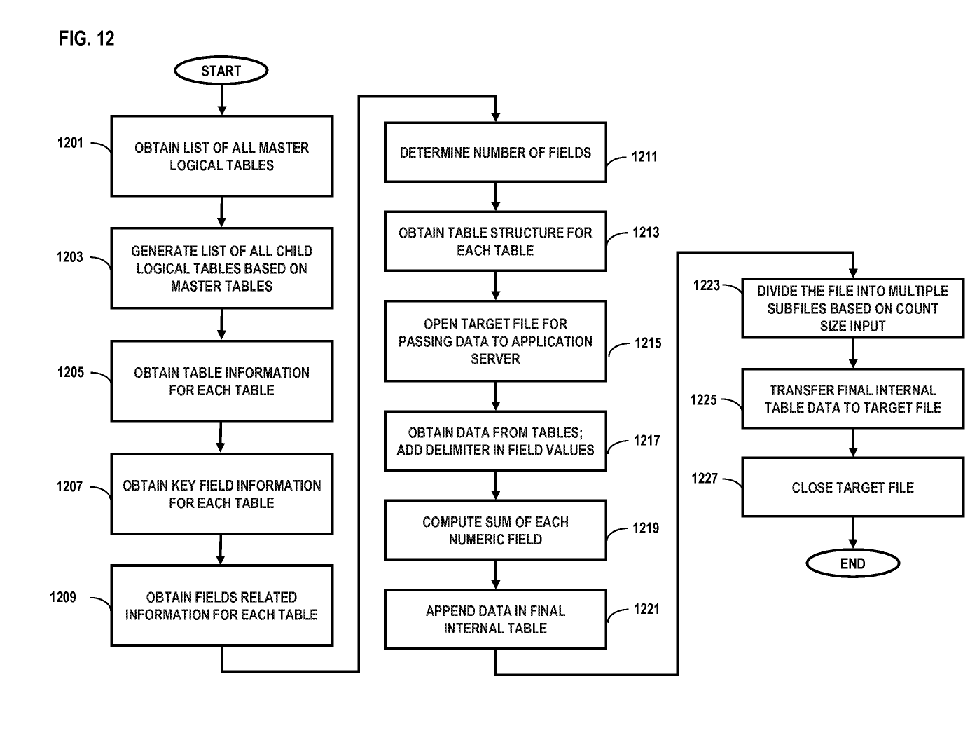

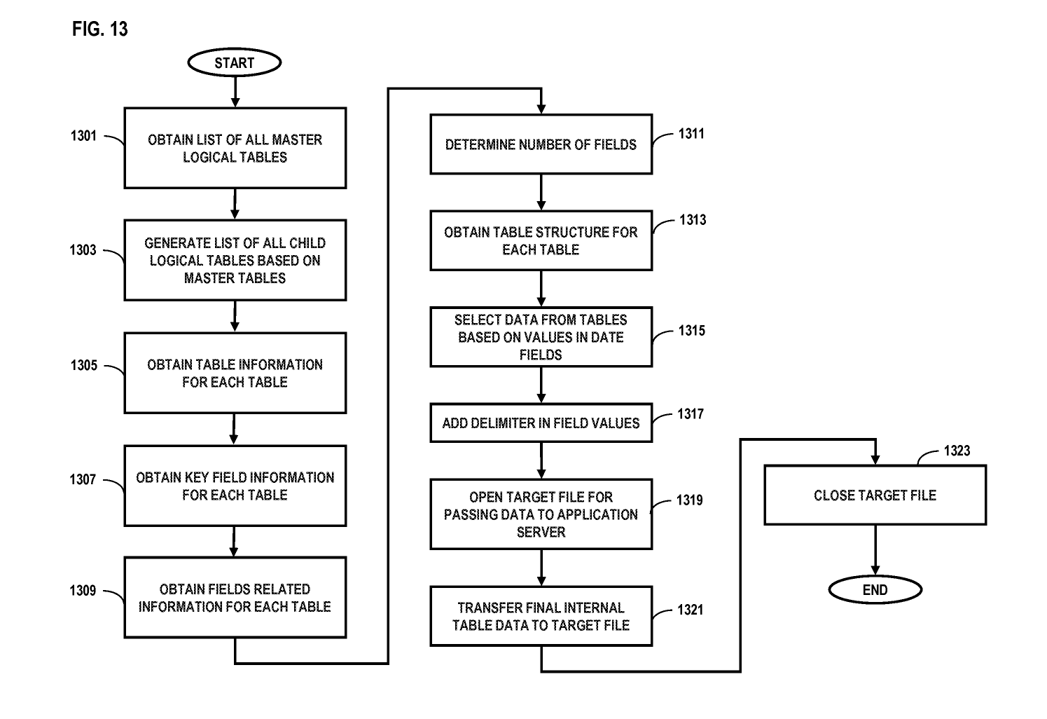

In step 431, the process validates the log file in the target system 303 for failed cases. For instance, if the target system 303 employs an Oracle® system, the log file can be generated by a Row Count application to qualify the failure cases. In step 433, indexes are created for commonly used logical tables. These indexes are used to speed execution of queries. Next, in step 435, data integrity of the logical tables on the target database management system 303d is tested by comparing attributes of logical tables in the source database with the same attributes of logical tables in the target database. Finally, in step 437, the integrity of the application specific scripts is tested. An exemplary process for testing data integrity will be described below with reference to FIGS. 12 and 13.

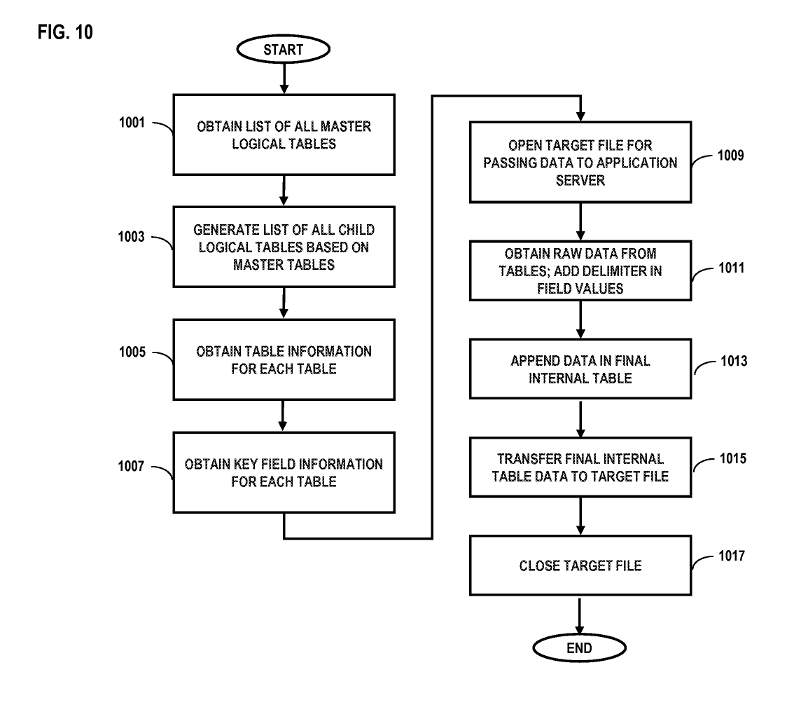

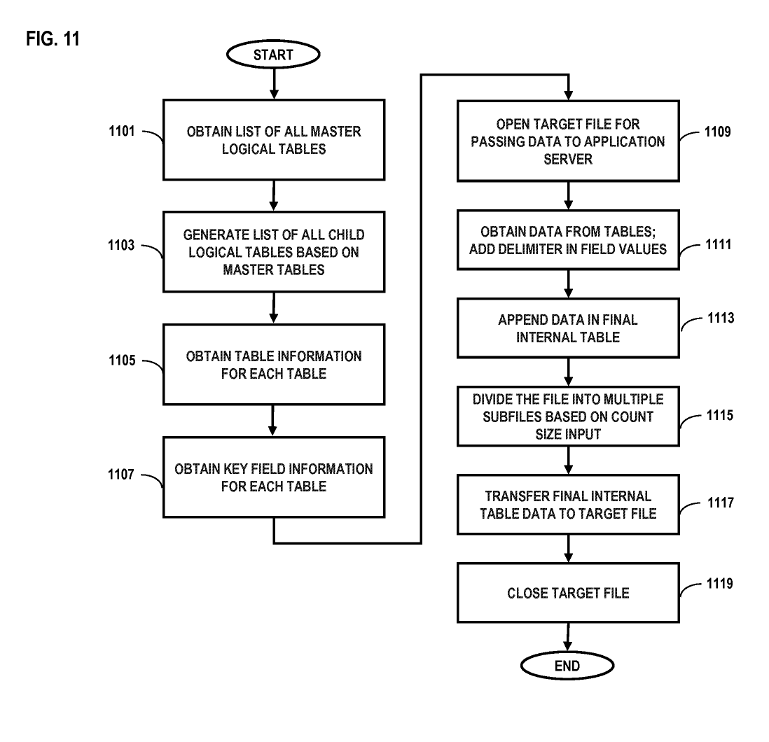

FIG. 5 is a flowchart of a process for extracting raw data from logical tables, according to an exemplary embodiment. This process provides for the extraction of raw data files from logical tables of the source system . In step 501, data from pooled tables is extracted by executing the ABAP program; e.g., “ZVR_TABLE_DOWNLOAD”. In step 503, ABAP program is invoked to extract data from a first subset of cluster tables, which includes all cluster tables except, e.g., BSEG, BSET, REGUP, CDPOS, and DOKTL tables. The cluster tables are extracted in flat files named after the pertinent table name. In step 505, data is extracted from a second subset of cluster tables that includes BSEG and BSET tables based on a plurality of parameter values that preferably include “company code” and “fiscal year.” This extraction is performed by executing the ABAP program “ZVR_TABLE_DOWNLOAD_BUKRS_GJAHR.” Once again, the data is extracted into flat files, according to certain embodiments. Specific exemplary processes for performing the raw data extraction are explained with reference to FIGS. 10 and 11 for relatively small and relatively large tables, respectively.

FIG. 6 is a flowchart of a process for loading raw data into the table structure on a target database management system, according to an exemplary embodiment. This process is explained, by way of example, using a DDL data structure. In step 601, DDL control files are built for each table transferred to the target database management system 303d. In step 603, the control files are executed to load the extracted raw logical table data into the table structure generated by the process step of 425 (FIG. 4). This step also results in the generation of log files that contain information regarding the data transfer process.

In step 605, the log files are examined to determine whether errors occurred during the data transfer process. If there are no such errors, the raw data loading process is complete. Otherwise, the process, per step 607, examines whether the errors are associated with the transfer of string objects. One type of common string object errors occurs in connection with processing strings that include quotation marks. If there are string related errors, the process, as in step 609, involves deleting the optionally enclosed fields and rerunning the corresponding control files.

Thereafter, in step 611, the process determines whether any errors occurred due to primary key constraints with null fields. If so, a space marker (‘ ’) can be inserted into each null field, as in step 613.

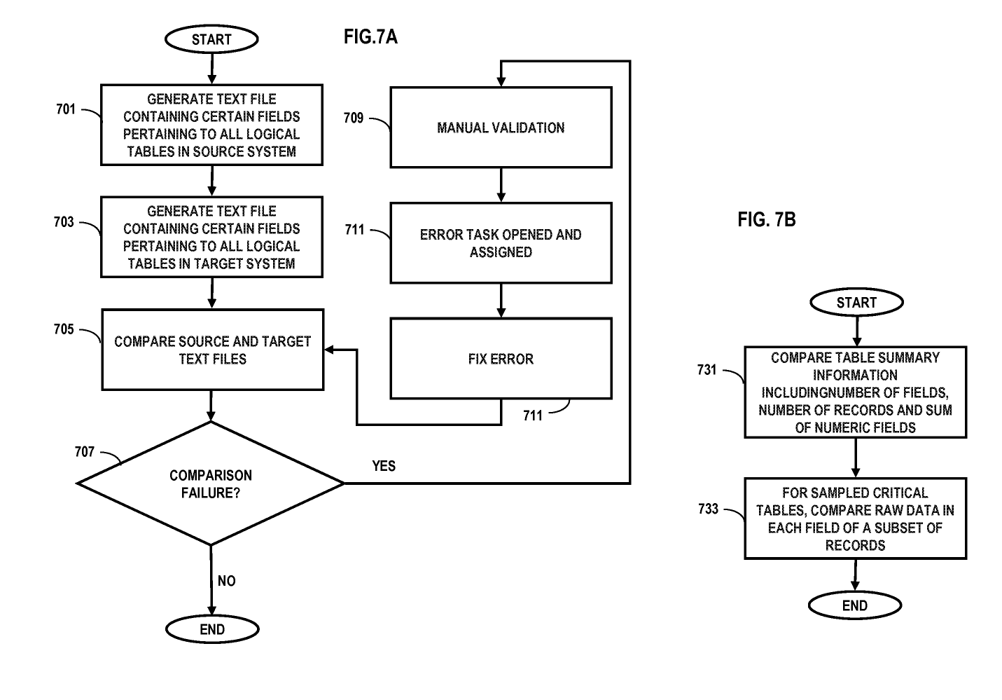

FIGS. 7A and 7B are a flowchart of a process for testing data integrity of tables transferred to a target database management system, according to an exemplary embodiment. As shown in FIG. 7A, in step 701, a text file is generated that contains a number of fields pertaining to each logical table in the source database. In certain embodiments, these fields include: 1) table name; 2) record count; 3) summation; 4) field count (null and not null) for date fields; 5) duplicate check; 6) summation check for numeric and currency fields; 7) table check; and 8) field check. An exemplary process for obtaining field count and record counts will be described below with reference to FIG. 12. In step 703, a text file is written that contains these fields pertaining to each logical table in the target database. Next, the source and target text files are compared, as in step 705. An exemplary process for validating date fields will be described below with reference to FIG. 13.

In step 707, the process checks whether the comparison failed for any tables, as will be further described with reference to FIG. 7B. If all of the target and source text files match, the data validation process is complete. Otherwise, manual validation occurs, as in step 709. In step 711, an error task is opened and assigned to a human agent; and in step 713, the error is fixed (or otherwise resolved). Alternatively, the process can resolve the error task through an automated process, e.g., involving an expert system.

FIG. 7B shows the steps involved in comparing source and target text files associated with step 705 of FIG. 7B. In step 731, for each logical table, table summary information is compared, including, e.g.,: 1) number of fields; 2) number of records; and 3) the sum of numeric fields are compared. Any discrepancy between field values results in the table being tagged for correction according to steps 709-713 of FIG. 7A. In step 733, for a sample of critical tables, an additional comparison is made. In particular, between, for example, 20 and 25 records are extracted from the source and target tables, respectively, and the raw data in each field of these records is compared. Again, any discrepancy between field values results in the table being tagged for correction according to steps 709-713 of FIG. 7A.

FIG. 8 is a flowchart of a process for extracting table structure files for logical tables according to an exemplary embodiment. In step 801, a list of master logical tables is generated. In step 803, a list of all child logical tables is generated based on the master tables. Next, as in step 805, the table information is obtained for each table. Also, the key field information is obtained for each table, per step 807. In step 809, the source data type names and length are converted to target data type names and length. A target file is then opened for passing data to, for example, an application server (not shown) within target system 303. In step 813, the data is transferred to the target file; and in step 815, the target file is closed.

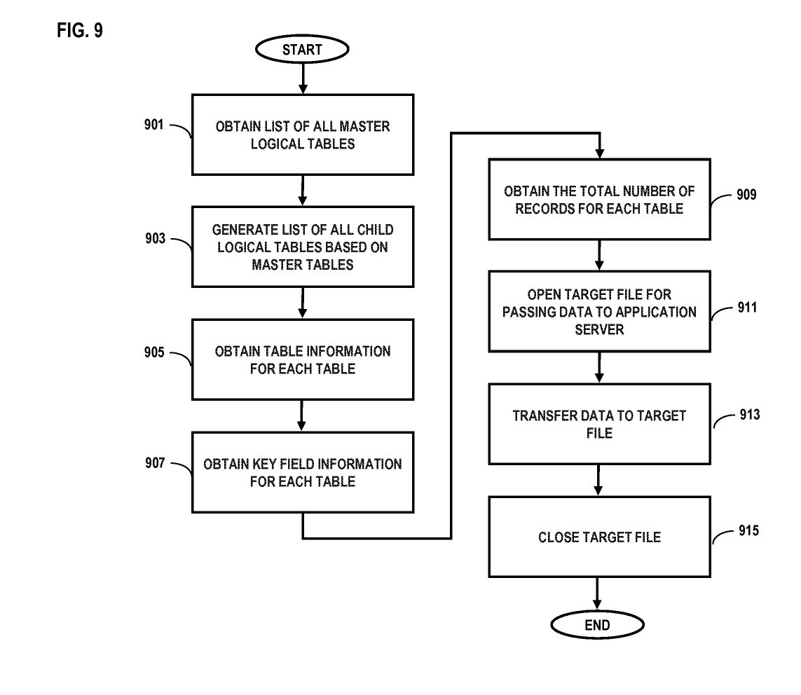

FIG. 9 is a flowchart of a process for determining the number of records in logical tables according to an exemplary embodiment. This process includes a number steps that are similar to the process of FIG. 8 Notably, in steps 901 and 903, a list of master logical tables and a list of all child logical tables are generated based on the master tables. In step 905, for each table, the table information is determined, and the key field information is obtained for each table (step 907).

Unlike the process of FIG. 8, in step 909, the total number of records is also obtained for each table. Steps 911-915 are similar to steps 811-813 of FIG. 8. That is, a target file is created for passing data to an application server within target system 303, whereby the data is transferred to the target file, which is then closed.

FIG. 10 is a flowchart of a process for extracting raw data from logical tables that are smaller than specified limits, according to an exemplary embodiment. In this process, steps 1001-1007 (which resembles steps 801-807 of FIG. 8) involve the generation or otherwise acquisition of the list of master logical tables and associated child logical tables, wherein the table information and key field information are obtained for each of the tables. In step 1009, a target file is opened to pass data to the target system 303 via an application server. In step 1011, raw data is obtained from the pertinent tables, and delimiters are added in field values. The data is appended, as in step 1013, in a final internal table. In step 1015, the final internal table data is transferred to a target file. Subsequently, the target file is closed, per step 1017.

FIG. 11 is a flowchart of a process for extracting raw data from logical tables that are greater than specified limits, according to an exemplary embodiment. As with the previous process of FIG. 10 relating to the extraction of raw data from logical tables, the scenario of FIG. 11 pertains to the case in which the record limit is exceeded. As such, the process, per steps 1101-1107, performs the generation of the list of master logical tables and associated child logical tables. Additionally, the table information and key field information are obtained for each of the tables. Further, a target file is created to forward the data to the application server of the target system 303 (step 1109). Per step 1111, data is obtained from the relevant tables, whereby delimiters are added in field values as appropriate. In step 1113, data is appended in a final internal table. In step 1115, the file is partitioned (or divided) into multiple subfiles based on count size input. Next, a final internal table is transferred to a target file, which is then closed (per steps 1117 and 1119).

FIG. 12 is a flowchart of a process for obtaining field count and row count information from logical tables according to an exemplary embodiment. The field and row count information is used in connection with the data integrity testing process described with respect to FIGS. 7A and 7B. The process of FIG. 12, according to one embodiment, include steps 1201-1207 resembling that of steps 1101-1107 of the process of FIG. 11. In step 1209, the process obtains fields related information for each table. In step 1211, the number of fields is determined. In step 1213, table structure information is obtained. Next, a target file is created for sending data to the application server of the target system 303 (step 1215). In step 1217, data is obtained from the relevant tables, and the process introduces delimiters in the field values. Thereafter, the sum of each numeric field is computed, as in step 1219. At this juncture, the process performs the steps 1221-1227, which are similar to steps 1113-1119 of FIG. 11, whereby data is appended in a final internal table, and the file is divided into subfiles. The final internal table is then forwarded to the target file; the target file is then closed.

FIG. 13 is a flowchart of a process for validating date fields between source and target logical tables, according to an exemplary embodiment. In this process, steps 1301-1313 follow the steps 1201-1211 of the previously described process. However, in step 1315, this process selects data from the tables based on dates—i.e., values of the date fields. Next, the process introduces delimiters in the field values, as in step 1317. Per steps 1319-1323, the process produces a target file, transfers the final internal table to the target file, and closes the target file.

The above arrangement, according to certain embodiments, advantageously provide an efficient approach to migrating data involving systems with differing data structures.

The processes described herein for providing data migration may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

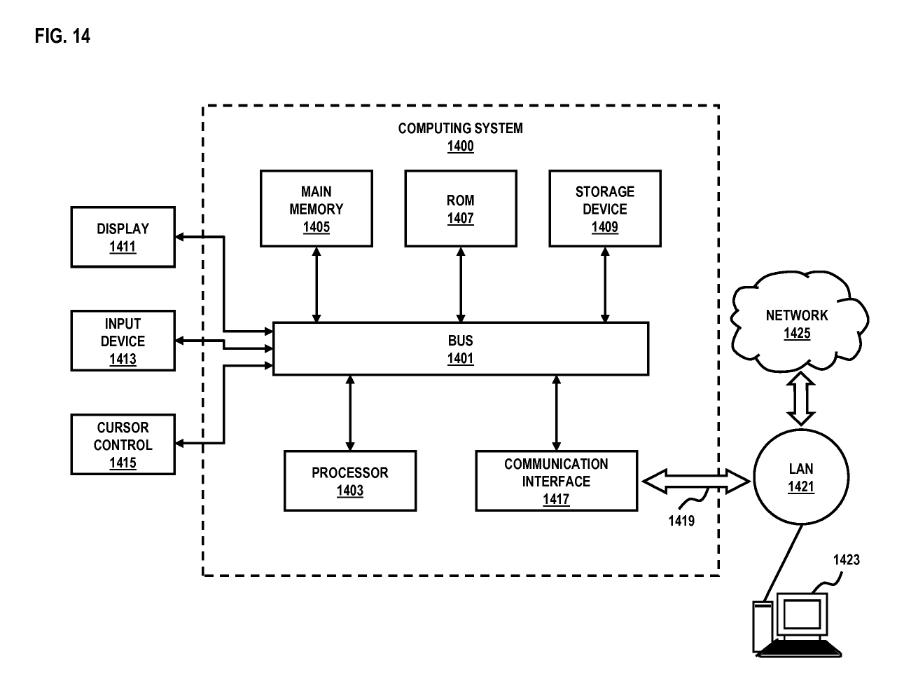

FIG. 14 illustrates computing hardware (e.g., computer system) 1400 upon which exemplary embodiments can be implemented. The computer system 1400 includes a bus 1401 or other communication mechanism for communicating information and a processor 1403 coupled to the bus 1401 for processing information. The computer system 1400 also includes main memory 1405, such as a random access memory (RAM) or other dynamic storage device, coupled to the bus 1401 for storing information and instructions to be executed by the processor 1403. Main memory 1405 can also be used for storing temporary variables or other intermediate information during execution of instructions by the processor 1403. The computer system 1400 may further include a read only memory (ROM) 1407 or other static storage device coupled to the bus 1401 for storing static information and instructions for the processor 1403. A storage device 1409, such as a magnetic disk or optical disk, is coupled to the bus 1401 for persistently storing information and instructions.

The computer system 1400 may be coupled via the bus 1401 to a display 1411, such as a cathode ray tube (CRT), liquid crystal display, active matrix display, or plasma display, for displaying information to a computer user. An input device 1413, such as a keyboard including alphanumeric and other keys, is coupled to the bus 1401 for communicating information and command selections to the processor 1403. Another type of user input device is a cursor control 1415, such as a mouse, a trackball, or cursor direction keys, for communicating direction information and command selections to the processor 1403 and for controlling cursor movement on the display 1411.

According to an exemplary embodiment, the processes described herein are performed by the computer system 1400, in response to the processor 1403 executing an arrangement of instructions contained in main memory 1405. Such instructions can be read into main memory 1405 from another computer-readable medium, such as the storage device 1409. Execution of the arrangement of instructions contained in main memory 1405 causes the processor 1403 to perform the process steps described herein. One or more processors in a multi-processing arrangement may also be employed to execute the instructions contained in main memory 1405. In alternative embodiments, hard-wired circuitry may be used in place of or in combination with software instructions to implement exemplary embodiments. Thus, exemplary embodiments are not limited to any specific combination of hardware circuitry and software.

The computer system 1400 also includes a communication interface 1417 coupled to bus 1401. The communication interface 1417 provides a two-way data communication coupling to a network link 1419 connected to a local network 1421. For example, the communication interface 1417 may be a digital subscriber line (DSL) card or modem, an integrated services digital network (ISDN) card, a cable modem, a telephone modem, or any other communication interface to provide a data communication connection to a corresponding type of communication line. As another example, communication interface 1417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1417 sends and receives electrical, electromagnetic, or optical signals that carry digital data streams representing various types of information. Further, the communication interface 1417 can include peripheral interface devices, such as a Universal Serial Bus (USB) interface, a PCMCIA (Personal Computer Memory Card International Association) interface, etc. Although a single communication interface 1417 is depicted in FIG. 14, multiple communication interfaces can also be employed.

The network link 1419 typically provides data communication through one or more networks to other data devices. For example, the network link 1419 may provide a connection through local network 1421 to a host computer 1423, which has connectivity to a network 1425 (e.g. a wide area network (WAN) or the global packet data communication network now commonly referred to as the “Internet”) or to data equipment operated by a service provider. The local network 1421 and the network 1425 both use electrical, electromagnetic, or optical signals to convey information and instructions. The signals through the various networks and the signals on the network link 1419 and through the communication interface 1417, which communicate digital data with the computer system 1400, are exemplary forms of carrier waves bearing the information and instructions.

The computer system 1400 can send messages and receive data, including program code, through the network(s), the network link 1419, and the communication interface 1417. In the Internet example, a server (not shown) might transmit requested code belonging to an application program for implementing an exemplary embodiment through the network 1425, the local network 1421 and the communication interface 1417. The processor 1403 may execute the transmitted code while being received and/or store the code in the storage device 1409, or other non-volatile storage for later execution. In this manner, the computer system 1400 may obtain application code in the form of a carrier wave.

The term “computer-readable medium” as used herein refers to any medium that participates in providing instructions to the processor 1403 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1409. Volatile media include dynamic memory, such as main memory 1405. Transmission media include coaxial cables, copper wire and fiber optics, including the wires that comprise the bus 1401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

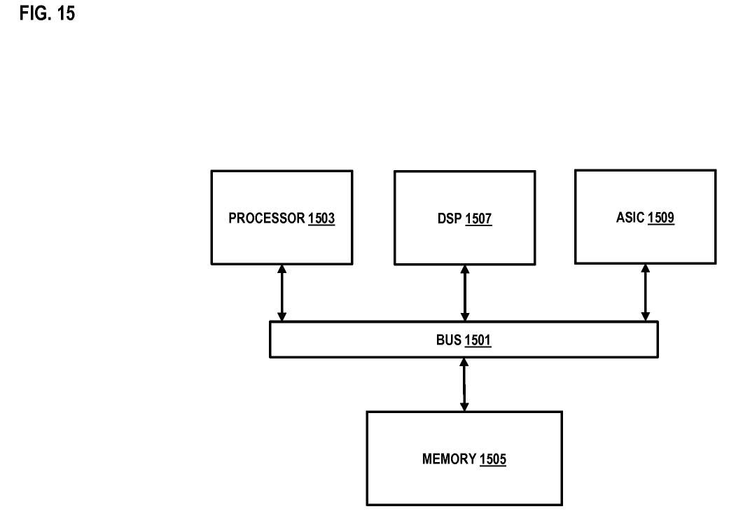

FIG. 15 illustrates a chip set 1500 upon which an embodiment of the invention may be implemented. Chip set 1500 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1500, or a portion thereof, constitutes a means for performing one or more steps of FIGS. 2, 6, 7, and 9A-9D.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to presenting a slideshow via a set-top box. The memory 1505 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method executed by one or more processors, comprising:
extracting table structure data associated with a logical table from a source database;
extracting raw data associated with the logical table from the source database;
generating a table structure in a target database based on the table structure data; and
loading the raw data into the table structure in the target database.

2. A method according to claim 1, wherein the logical table includes at least one of a pooled table, a cluster table, or a combination thereof.

3. A method according to claim 1, further comprising:
generating table summary information associated with the logical table in the source database;
generating table summary information associated with the logical table in the target database; and
comparing the table summary information associated with the source database with the table summary information associated with the target database.

4. A method according to claim 3, wherein the table summary information includes one or more of the following: number of fields in the logical table; number of records in the logical table; and the sum of numeric fields in the logical table.

5. A method according to claim 1, further comprising:
comparing raw data in each field of a subset of records from the logical table in the source database with the corresponding records from the logical table in the target database.

6. A method according to claim 1, wherein the table structure is extracted by obtaining data definition language scripts from the source database.

7. A method according to claim 1, wherein the table structure is generated by executing data definition language scripts in the target database.

8. A method according to claim 1, further comprising:
determining the size of the logical table;
determining file size limits for the target database;
if the logical table exceeds the file size limits, dividing the logical table into multiple subfiles;
separately transferring the multiple subfiles to the target database; and
wherein the raw data is loaded from the multiple subfiles.

9. A method according to claim 1, wherein the logical table contains information pertaining to business management services.

10. A method according to claim 1, wherein the source database utilizes a different data structure than the target database.

11. A method according to claim 1, wherein the logical table is represented in the source database as a plurality of entries in a physical table that includes information pertaining to other logical tables.

12. An apparatus comprising:
at least one processor; and
at least one memory including computer program code,
the at least one memory and the computer program code configured to, with the at least one processor, cause the apparatus to perform at least the following,
extract table structure data associated with a logical table from a source database,
extract raw data associated with the logical table from the source database,
generate a table structure in a target database based on the table structure data, and
load the raw data into the table structure in the target database.

13. An apparatus according to claim 12, wherein the logical table includes at least one of a pooled table, a cluster table, or a combination thereof.

14. An apparatus according to claim 12, wherein the apparatus is further caused, at least in part, to:
generate table summary information associated with the logical table in the source database,
generate table summary information associated with the logical table in the target database, and
compare the table summary information associated with the source database with the table summary information associated with the target database.

15. An apparatus according to claim 14 wherein the table summary information includes one or more of the following: number of fields in the logical table; number of records in the logical table; and the sum of numeric fields in the logical table.

16. An apparatus according to claim 12 further comprising:
compare raw data in each field of a subset of records from the logical table in the source database with the corresponding records from the logical table in the target database.

17. An apparatus according to claim 12 wherein the table structure is extracted by obtaining data definition language scripts from the source database.

18. An apparatus according to claim 12 wherein the table structure is generated by executing data definition language scripts in the target database.

19. An apparatus according to claim 12, wherein the apparatus is further caused, at least in part, to:
obtain the size of the logical table,
obtain file size limits for the target database,
if the logical table exceeds the file size limits, dividing the logical table into multiple subfiles,
separately transferring the multiple subfiles to the target database; and
wherein the raw data is loaded from the multiple subfiles.

20. An apparatus according to claim 12, wherein the logical table contains information pertaining to business management services.

21. An apparatus according to claim 12, wherein the source database utilizes a different data structure than the target database.

22. An apparatus according to claim 12, wherein the logical table is represented in the source database as a plurality of entries in a physical table that includes information pertaining to other logical tables.
